(19) United States
(12) Patent Application Publication
(10) Pub. No.: US 2008/0235031 A1
(43) Pub. Date: Sep. 25, 2008

(54) Interface apparatus, interface processing method, and interface processing program

(75) Inventor: Daisuke Yamamoto, Kawasaki-Shi (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 12/076,104

(22) Filed: Mar. 13, 2008

(30) Foreign Application Priority Data
Mar. 19, 2007 (JP) 2007-70456

(51) Int. Cl. G10L 21/06

(52) U.S. Cl. 704/275; 704/E21.019

(57) ABSTRACT

An interface apparatus according to an embodiment of the invention includes: an operation detecting section configured to detect a device operation; a status detecting section configured to detect a status change or status continuance of a device or in the vicinity of the device; an operation history accumulating section configured to accumulate a operation detection result and a status detection result in association with each other; an operation history matching section configured to match a status detection result for a newly detected against accumulated status detection results, and select a device operation that corresponds to the status detection result for the newly detected; and an utterance section configured to utter as sound a word corresponding to the selected device operation.

### CROSS REFERENCE TO RELATED APPLICATIONS

This application is based upon and claims the benefit of priority from the prior Japanese Patent Application No. 2007-70456, filed on Mar. 19, 2007, the entire contents of which are incorporated herein by reference.

### BACKGROUND OF THE INVENTION

1. Field of the Invention

The present invention relates to an interface apparatus, an interface processing method, and an interface processing program.

2. Background Art

In recent years, due to the development of information technology, household appliances have come to be connected to networks. Furthermore, due to the spread of broadband, household appliances have come to be employed to construct home networks in households. Such household appliances are called information appliances. Information appliances are useful to users.

On the other hand, interfaces between information appliances and users are not always user-friendly. Information appliances have come to provide various useful functions and various usages, but due to such a wide choice of functions, users have come to be required to make many selections to use functions they want to use; this causes user-unfriendliness of the interfaces. Therefore, there is a need for a user-friendly interface that serves as an intermediary between an information appliance and a user and allows every user to operate a device (information appliance) and to understand device information easily.

One of known interfaces having such features is a speech interface, which performs a device operation in response to a voice instruction from a user. Generally, in such a speech interface, voice instruction words for operating devices by voice are predetermined, so that users can operate devices easily by the predetermined voice instruction words. However, such a speech interface has a problem that users have to remember the predetermined voice instruction words. If they do not remember the predetermined voice instruction words, they tend to be at a loss regarding which voice instruction words to utter, when they operate devices.

As a method for solving this problem, such a method is known that presents a registered voice instruction word by showing it on a display, or by uttering it by voice in response to a voice instruction or screen operation of “Help”, as described in IP-A H6-95828 (KOKAI). However, when a number of voice instruction words should be presented, presentation by voice as in the latter example is troublesome, so that presentation on a display as in the former example is required.

There is also a known method that presents a voice instruction word which is used with a high frequency in a certain situation, based on past operation history and the like. However, when voice instruction words are presented based on operation history and the like, there can be a problem of presenting too many voice instruction words or conversely presenting no voice instruction word, depending on rules for presentation. When the rate of presentation is high, inappropriate presentations are obtrusive. On the other hand, when the rate of presentation is low, users cannot get appropriate presentations.

JP-A 2003-241790 (KOKAI) discloses a system that learns, as voice instruction words, words which are not common (e.g., user's favorite phrases and expressions unique to a family). In this case, since the system learns voice instruction words which are not common words, users do not have to remember predetermined voice instruction words. However, when they forget voice instruction words they has had the system learn, they can no longer use the system.

Information Processing Society of Japan 117th Human Interface Research Group Report, 2006-H1-117, 2006: “Research on a practical home robot interface by introducing friendly operations <an interface being operated and doing notification with user's words>”, discloses an interface apparatus that allows a user to operate a device with free words instead of predetermined voice instruction words.

### SUMMARY OF THE INVENTION

An embodiment of the present invention is, for example, an interface apparatus including: an operation detecting section configured to detect a device operation; a status detecting section configured to detect a status change or status continuance of a device or in the vicinity of the device; an operation history accumulating section configured to accumulate a operation detection result and a status detection result in association with each other; an operation history matching section configured to match a status detection result for a newly detected against accumulated status detection results, and select a device operation that corresponds to the status detection result for the newly detected; and an utterance section configured to utter as sound a word corresponding to the selected device operation.

Another embodiment of the present invention is, for example, an interface processing method including: detecting a device operation; detecting a status change or status continuance of a device or in the vicinity of the device; accumulating a operation detection result and a status detection result in association with each other; matching a status detection result for a newly detected against accumulated status detection results, and selecting a device operation that corresponds to the status detection result for the newly detected; and uttering as sound a word corresponding to the selected device operation.

Another embodiment of the present invention is, for example, an interface processing method including: detecting a status change or status continuance of a device or in the vicinity of the device; querying a user by voice about the meaning of the detected status change or status continuance; performing speech recognition or having a speech recognizing unit perform speech recognition, for a teaching speech uttered by the user in response to the query, the speech recognizing unit being configured to perform speech recognition; accumulating a recognition result for the teaching speech and a status detection result in association with each other; performing speech recognition or having a speech recognizing unit perform speech recognition, for an instructing speech uttered by a user for a device operation, the speech recognizing unit being configured to perform speech recognition; selecting, based on a matching result of matching a recognition result for the instructing speech against accumulated recognition results for teaching speeches, a device operation specified by a status detection result that corresponds to the recognition result for the instructing speech; performing the selected device operation; detecting the performed device operation; detecting a status change or status continuance of a device or in the vicinity of the device; accumulating a operation detection result and a status detection result in association with each other; matching a status detection result for a newly detected against accumulated status detection results, and selecting a device operation that corresponds to the status detection result for the newly detected; and retrieving a word corresponding to the selected device operation, from words which are obtained from the accumulated recognition results for teaching speeches, and uttering the retrieved word as sound.

Another embodiment of the present invention is, for example, an interface processing program of having a computer perform an interface processing method, the method including: detecting a device operation; detecting a status change or status continuance of a device or in the vicinity of the device; accumulating a operation detection result and a status detection result in association with each other; matching a status detection result for a newly detected against accumulated status detection results, and selecting a device operation that corresponds to the status detection result for the newly detected; and uttering as sound a word corresponding to the selected device operation.

Another embodiment of the present invention is, for example, an interface processing program of having a computer perform an interface processing method, the method including: detecting a status change or status continuance of a device or in the vicinity of the device; querying a user by voice about the meaning of the detected status change or status continuance; performing speech recognition or having a speech recognizing unit perform speech recognition, for a teaching speech uttered by the user in response to the query, the speech recognizing unit being configured to perform speech recognition; accumulating a recognition result for the teaching speech and a status detection result in association with each other; performing speech recognition or having a speech recognizing unit perform speech recognition, for an instructing speech uttered by a user for a device operation, the speech recognizing unit being configured to perform speech recognition; selecting, based on a matching result of matching a recognition result for the instructing speech against accumulated recognition results for teaching speeches, a device operation specified by a status detection result that corresponds to the recognition result for the instructing speech; performing the selected device operation; detecting the performed device operation; detecting a status change or status continuance of a device or in the vicinity of the device; accumulating a operation detection result and a status detection result in association with each other; matching a status detection result for a newly detected against accumulated status detection results, and selecting a device operation that corresponds to the status detection result for the newly detected; and retrieving a word corresponding to the selected device operation, from words which are obtained from the accumulated recognition results for teaching speeches, and uttering the retrieved word as sound.

### BRIEF DESCRIPTION OF THE DRAWINGS

FIG. 1 shows a configuration of an interface apparatus according to a first embodiment;

FIG. 2 illustrates the operation of the interface apparatus according to the first embodiment;

FIG. 3 illustrates a way of utterance, such as changing the volume of utterance in accordance with the degree of similarity;

FIG. 4 illustrates a way of utterance, such as changing the number of utterances in accordance with the degree of similarity;

FIG. 5 shows a configuration of an interface apparatus according to a second embodiment;

FIG. 6 illustrates the operation of the interface apparatus according to the second embodiment;

FIG. 7 shows a configuration of an interface apparatus according to a third embodiment;

FIG. 8 illustrates the operation of the interface apparatus according to the third embodiment;

FIG. 9 shows an example of accumulated data in an operation history accumulating section according to a fourth embodiment;

FIG. 10 illustrates the operation of the interface apparatus according to the fourth embodiment; and

FIG. 11 illustrates an interface processing program.

### DESCRIPTION OF THE EMBODIMENTS

This specification is written in English, while the specification of the prior Japanese Patent Application No. 2007-70456 is written in Japanese. Embodiments described below relate to a speech processing technique, and contents of this specification originally relate to speeches in Japanese, so Japanese words are expressed in this specification as necessary. The speech processing technique of the embodiments described below is applicable to English, Japanese, and other languages as well.

Embodiments of the present invention will be described below with reference to the drawings.

### First Embodiment

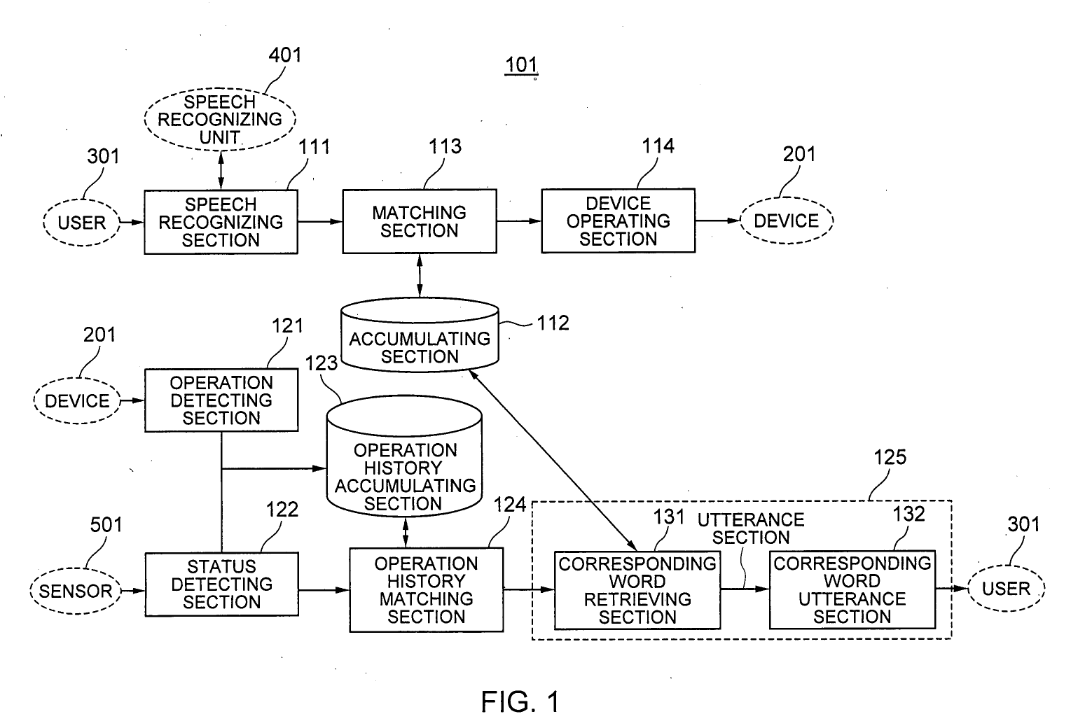

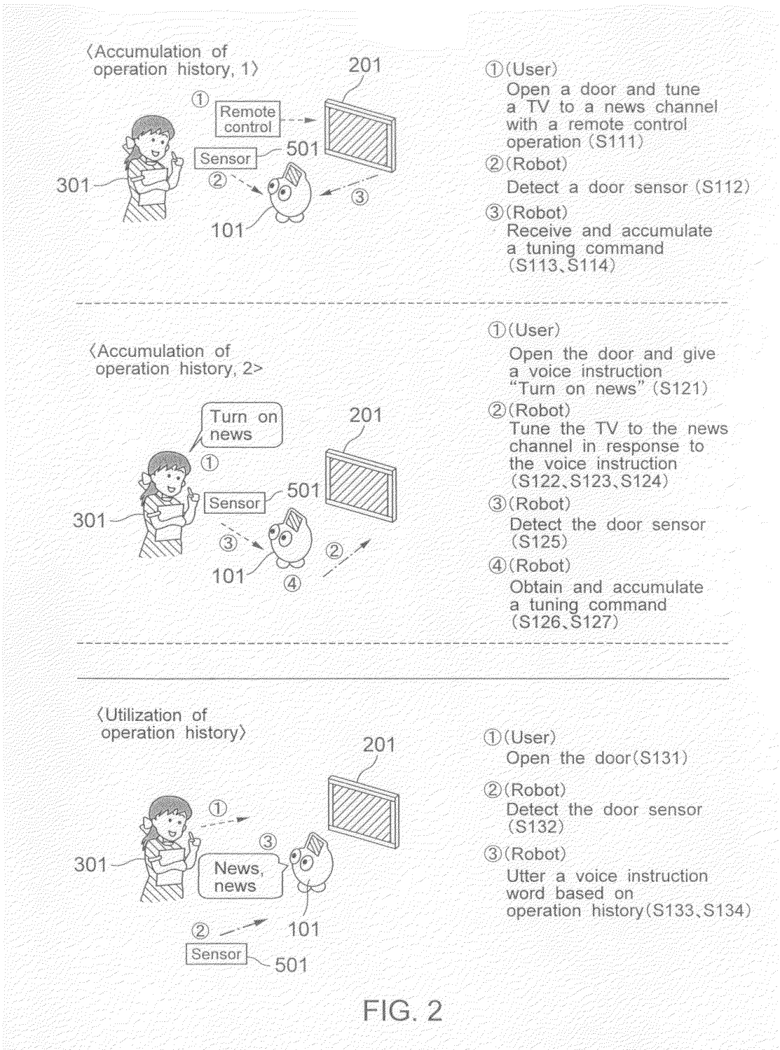

FIG. 1 shows a configuration of an interface apparatus 101 according to a first embodiment. FIG. 2 illustrates the operation of the interface apparatus 101 in FIG. 1. The interface apparatus 101 is a robot-shaped speech interface apparatus having friendly-looking physicality. The interface apparatus 101 has voice input function and voice output function, and provides a speech interface serving as an intermediary between a device 201 and a user 301.

As shown in FIG. 1, the interface apparatus 101 includes a speech recognizing section 111, an accumulating section 112, a matching section 113, a device operating section 114, an operation detecting section 121, a status detecting section 122, an operation history accumulating section 123, an operation history matching section 124, and an utterance section 125 that has a corresponding word retrieving section 131 and a corresponding word utterance section 132.

The speech recognizing section 111 is a block which performs speech recognition or has a speech recognizing unit 401 perform speech recognition, for an instructing speech uttered by a user for a device operation. The speech recognizing unit 401 is configured to perform speech recognition. The accumulating section 112 is a block which accumulates information identifying the device operation and a word corresponding to the device operation in association with each other. The matching section 113 is a block which selects, based on a matching result of matching a recognition result for the instructing speech against accumulated words, a device operation that corresponds to the recognition result for the instructing speech. The device operating section 114 is a block which performs the selected device operation.

The operation detecting section 121 is a block which detects a device operation. The status detecting section 122 is a block which detects a status change or status continuance of a device or in the vicinity of the device. The operation history accumulating section 123 is a block which accumulates a detection result for the device operation (a operation detection result) and a detection result for the status change or status continuance (a status detection result) in association with each other. The operation history matching section 124 is a block which matches a detection result for a newly detected status change or status continuance against accumulated detection results for status changes or status continuances, and selects a device operation that corresponds to the detection result for the newly detected status change or status continuance. The utterance section 125 is a block which utters as sound a word corresponding to the selected device operation. In the utterance section 125, the corresponding word retrieving section 131 retrieves the word to utter from accumulated words, and the corresponding word utterance section 132 utters the retrieved word as sound.

The following description will describe, as an example of the device 201, a television for multi-channel era. Specifically, the following description will illustrate a device operation for tuning the television to a news channel, and describe the operation of the interface apparatus 101.

As shown in FIG. 2, operation phases of the interface apparatus 101 include an operation history accumulating phase in which an operation history of the device 201 is accumulated, and an operation history utilizing phase in which the operation history of the device 201 is utilized.

Suppose that in the evening on a day, the user 301 comes back home, and opens a door to enter a room, where he/she operates a remote control with his/her hand to tune the television 201 to the news channel (S111). At this time, the status detecting section 122 of the interface apparatus 101 detects a status change in the vicinity of the television 201 such that the door was opened, with a door sensor 501 attached on the door (S112). The status detecting section 122 also acquires time information about the time of the detection, from a timer or the like. In addition, the operation detecting section 121 of the interface apparatus 101 receives a remote control signal associated with the operation of tuning the television 201 to the news channel (S113). As a result of this, the operation detecting section 121 detects a device operation performed by the user 301 such that the television 201 was tuned to the news channel.

If the television 201 is connected to a network, the operation detecting section 121 receives the remote control signal from the television 201 via the network, or if the television 201 is not connected to a network, the operation detecting section 121 receives the remote control signal directly from the remote control. Then, the interface apparatus 101 accumulates a detection result for the status change such that the door was opened, a detection result for the device operation such that the television 201 was tuned to the news channel, and the time information representing the time of these detections in association with one another, in the operation history accumulating section 123 (S114).

Suppose that in the evening on another day, the user 301 comes back home, and opens the door to enter the room, where he/she says “Turn on news” to the interface apparatus 101 in order to turn on the television 201 and watch the news channel (S121). In response to it, the speech recognizing section 111 of the interface apparatus 101 performs speech recognition, for the instructing speech “Turn on news” uttered by the user 301 for a device operation (S122). The speech recognizing section 111 may have the speech recognizing unit 401 perform speech recognition for the instructing speech, instead of performing speech recognition for the instructing speech by itself. The speech recognizing unit may be provided inside of the interface apparatus 101, or outside of the interface apparatus 101. Examples of the speech recognizing unit 401 include a speech recognition server, a speech recognition board, and a speech recognition engine.

In the interface apparatus 101, information that identifies the device operation of tuning the TV to the news channel, and the word “news” which corresponds to the device operation of tuning the TV to the news channel, are previously accumulated in association with each other, in the accumulating section 112. In the accumulating section 112, such identifying information and corresponding words for various other device operations are previously accumulated in association with each other. The speech recognizing section 111 performs, as speech recognition for the instructing speech “Turn on news”, isolated word recognition which utilizes these words as standby words. More specifically, the speech recognizing section 111 matches a recognition result for the instructing speech against these words, and determines whether or not any of these words is contained in the recognition result for the instructing speech. This provides a matching result such that the recognition result for the instructing speech “Turn on news” contains the word “news”.

Then, the matching section 113 of the interface apparatus 101 selects, based on the matching result of matching the recognition result for the instructing speech “Turn on news” against the accumulated words in the accumulating section 112, a device operation that corresponds to the recognition result for the instructing speech “Turn on news” (S123). Here, based on the matching result such that the recognition result for the instructing speech “Turn on news” contains the word “news”, a device operation of tuning the TV to the news channel is selected.

Then, the device operating section 114 of the interface apparatus 101 performs the device operation selected by the matching section 113 (S124). That is, the television 201 is turned on and tuned to the news channel. During the course of this process, the status detecting section 122 of the interface apparatus 101 detects a status change in the vicinity of the television 201 such that the door was opened, with the door sensor 501 attached on the door (S125). The status detecting section 122 also acquires time information about the time of the detection, from a timer or the like. In addition, the operation detecting section 121 of the interface apparatus 101 acquires a signal associated with the operation of tuning the television 201 to the news channel (S126). As a result of this, the operation detecting section 121 detects a device operation performed by the interface apparatus 101 in response to the voice instruction from the user 301, the device operation being such that the television 201 was tuned to the news channel.

Then, the interface apparatus 101 accumulates a detection result for the status change such that the door was opened, a detection result for the device operation such that the television 201 was tuned to the news channel, and the time information representing the time of these detections in association with one another, in the operation history accumulating section 123 (S127).

In this manner, the interface apparatus 101 accumulates an operation history of a performed device operation, every time the user 301 performs a device operation or the interface apparatus 101 performs a device operation in response to a voice instruction given by the user 301. Operation histories accumulated in the operation history accumulating phase will be utilized in the subsequent operation history utilizing phase.

Suppose that in the evening on a day, the user 301 comes home, and opens the door to enter the room (S131). At this time, the status detecting section 122 of the interface apparatus 101 detects a status change in the vicinity of the television 201 such that the door was opened, with the door sensor 501 attached on the door (S132). The status detecting section 122 also acquires time information about the time of the detection, from a timer or the like. Then, the operation history matching section 124 of the interface apparatus 101 matches a detection result for this newly detected status change or status continuance against detection results for status changes or status continuances which are accumulated in the operation history accumulating section 123, and selects a device operation that corresponds to the detection result for the newly detected status change or status continuance (S133).

In this matching process, the operation history matching section 124 matches the detection result for the newly detected status change or status continuance against accumulated detection results for status changes or status continuances, and quantifies the degree of similarity between the detection result for the newly detected status change or status continuance and an accumulated detection result for a status change or status continuance. That is to say, the operation history matching section 124 derives a numerical value representing what degree the new status detection result is similar to an accumulated status detection result, according to predetermined rules for quantification. The degree of similarity can be quantified, for example, by a method that uses N types of detection parameters such as the door being opened, it being detected in the evening, and it being detected on Friday, to represent each status detection result as a coordinate in N-dimensional space, and regards the (inverted) distance between coordinates as the degree of similarity between status detection results. The scale of the degree of similarity can be given, for example, as follows: the degree of similarity for an exact match is “1”, and the degree of similarity for an exact mismatch is “0”.

Then, the operation history matching section 124 selects a device operation that corresponds to the detection result for the newly detected status change or status continuance, based on the degree of similarity. Here, the operation history matching section 124 identifies a status detection result that has the highest degree of similarity to the new status detection result, from accumulated status detection results. Then, if the degree of similarity is equal to or greater than a threshold, the operation history matching section 124 determines that the new status detection result corresponds to the identified status detection result. Accordingly, a device operation that corresponds to the identified status detection result is selected as the device operation that corresponds to the new status detection result.

Step S133 will be described more specifically. At S133, the operation history matching section 124 quantifies the degree of similarity between the status detection result detected at S132 such that the door was opened in the evening and each of accumulated status detection results. As a result, the operation history matching section 124 identifies the status detection result accumulated at S114 or S127 such that the door was opened in the evening. It is assumed here that the degree of similarity between the status detection result detected at S132 and the status detection result accumulated at S114 or S127 is 0.9 and the threshold is 0.5. Since in this case the degree of similarity is greater than the threshold, it is determined that the status detection result detected at S132 corresponds to the status detection result accumulated at S114 or S127. Therefore, the device operation which corresponds to the status detection result accumulated at S114 or S127, i.e., tuning of the TV to the news channel, is selected as the device operation that corresponds to the status detection result detected at S132.

Then, the utterance section 125 of the interface apparatus 101 utters as sound a word that corresponds to the device operation selected by the operation history matching section 124 (S134). Here, a word that corresponds to the device operation of tuning the TV to the news channel is uttered as sound. This can remind the user 301 that he/she usually turns on the television 201 to watch the news channel after he/she comes home and enters the room in the evening. That is, it is possible to remind the user 301 of a certain act he/she performs in a certain situation. Consequently, the user 301 can turn on the television 201 and watch the news channel as usual.

As mentioned above, in the interface apparatus 101, information identifying a device operation and a word corresponding to the device operation are accumulated in association with each other, in the accumulating section 112. Consequently, a device operation and a word are associated with each other. For example, the device operation of tuning the TV to the news channel is associated with the word “news”.

Accordingly, at S134, the utterance section 125 retrieves a word to utter, i.e., a word that corresponds to the device operation selected by the operation history matching section 124, from words accumulated in the accumulating section 112. Here, the word “news” which corresponds to the device operation of tuning the TV to the news channel is acquired in this retrieval. Then, the utterance section 125 utters as sound the word “news” which is acquired in the retrieval. The utterance section 125 may utter the word alone, or may utter the word together with some other word like “I turned on news”.

In this embodiment, the accumulated words in the accumulating section 112 are used as standby words for isolated word recognition, in performing speech recognition for an instructing speech. Therefore, in this embodiment, the user 301 can utter the word “news” as an instructing speech, to have the interface apparatus 101 tune the TV to the news channel. In other words, the utterance by the utterance section 125 has an effect of presenting the user 301 with a voice instruction word “news” for tuning the TV to the news channel.

In this way, at S134, the utterance section 125 utters, as a word which corresponds to the selected device operation, a voice instruction word for the selected device operation. This can present the user 301 with a voice instruction word for a certain act which is performed in a certain situation by the user 301. The user 301 can utter the presented voice instruction word “news”, so as to turn on the television 201 and watch the news channel as usual.

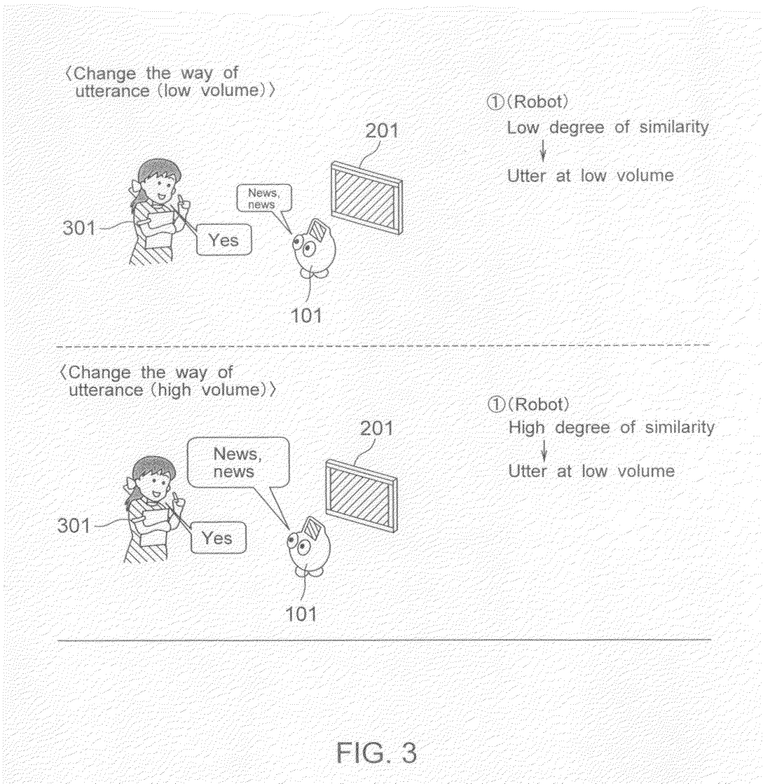

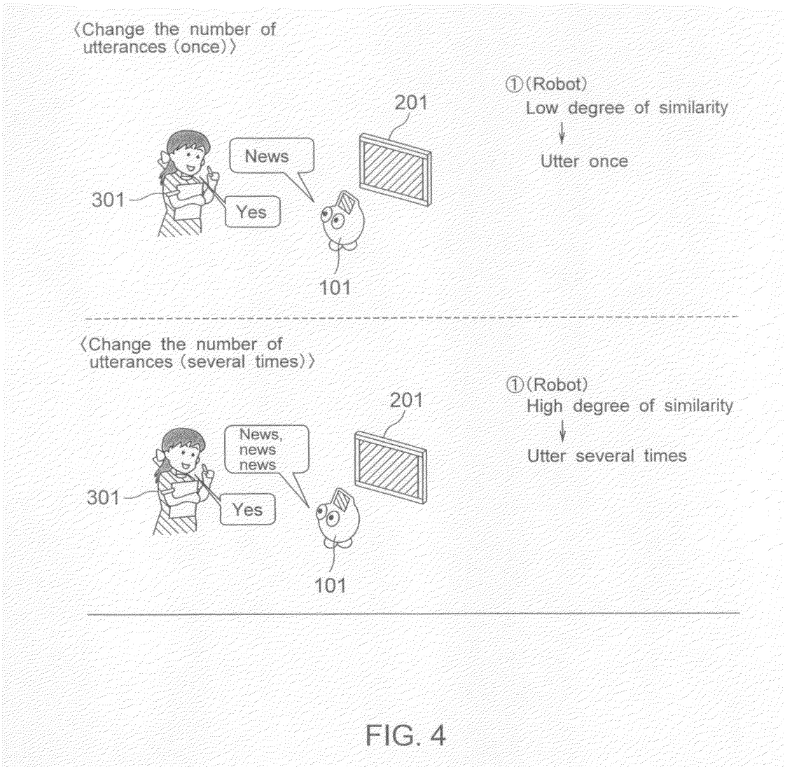

In this embodiment, at S134, the utterance section 125 utters the word in a manner depending on the degree of similarity. That is, the utterance section 125 changes the way of uttering the word, in accordance with the degree of similarity between the new status detection result and the identified status detection result. For example, as illustrated in FIG. 3, the utterance section 125 changes the volume of utterance in accordance with the degree of similarity; it utters “News” at low volume when the degree of similarity is low, and it utters “News” at high volume when the degree of similarity is high. For example, as illustrated in FIG. 4, the utterance section 125 changes the number of utterances in accordance with the degree of similarity; it utters once as “News” when the degree of similarity is low, and it utters several times as “News, news, news” when the degree of similarity is high. The interface apparatus 101, which is a robot, may utter the word with a physical movement such as tilting its head, in accordance with the degree of similarity.

In this way, at S134, the word is uttered in a manner depending on the degree of similarity. Thereby, in a situation which is so similar to an operation history, the word is uttered (i.e., the voice instruction word is presented) in a manner that easily attracts the user 301's attention. Conversely, in a situation which is not so similar to an operation history, the word is uttered (i.e., the voice instruction word is presented) in a manner that does not annoy the user 301. In each case, if the user 301 does not perform an operation after the utterance, the degree of similarity will become lower, and the manner of utterance will be made less annoying. Conversely, if the user 301 performs an operation after the utterance, the degree of similarity will become higher.

At S134, the interface apparatus 101 may utter a word corresponding to the selected device operation by the utterance section 125, and also perform the selected device operation by the device operating section 114. For example, the interface apparatus 101 may tune the television 201 to the news channel with uttering “News”.

While, in this embodiment, the status detecting section 122 detects a status change in the vicinity of the television 201 such that the door was opened, it may detect other status changes or status continuances. For example, the status detecting section 122 may detect a status continuance in the vicinity of the television 201 such that the door is open. For example, the status detecting section 122 may detect a status change or status continuance of the television 201 such that the television 201 was turned on or has been on. These detection results are processed in the way described above.

In this embodiment, information identifying a device operation and a word corresponding to the device operation are accumulated in association with each other, in the accumulating section 112. Here, the information is a command for the device operation, as described later. The information may be any information that can identify the device operation. Examples of the information include the name, the identification code, and the identification number of the device operation.

While this embodiment illustrates a case where one interface apparatus 101 handles one device 201, this embodiment is also applicable to a case where one interface apparatus 101 handles a plurality of devices 201.

### Second Embodiment

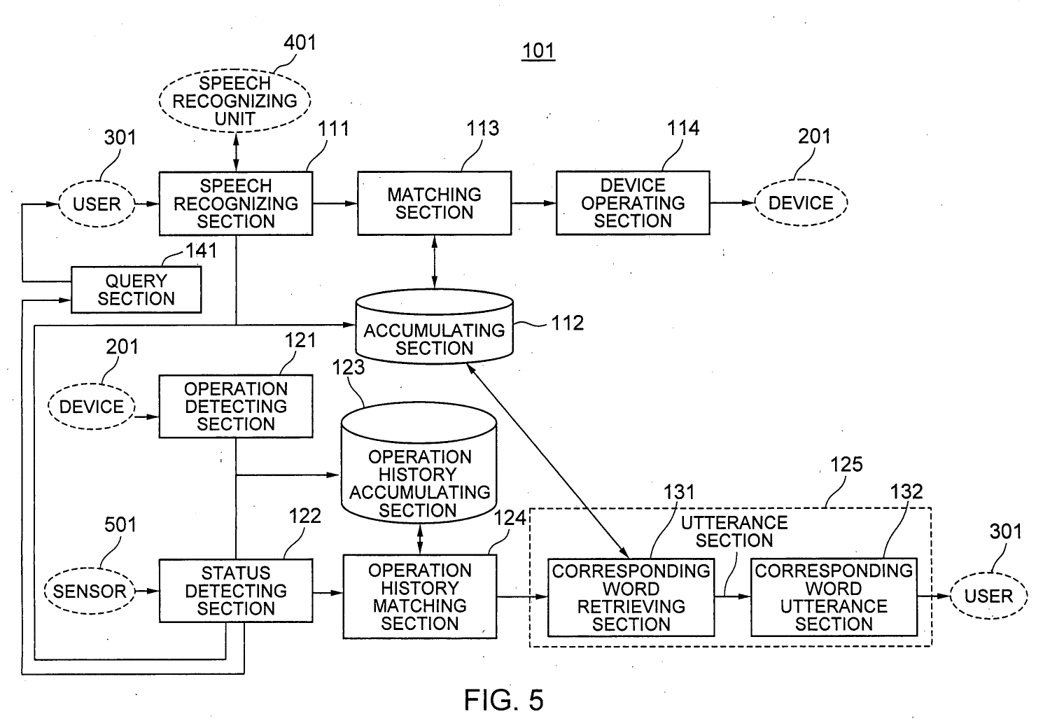

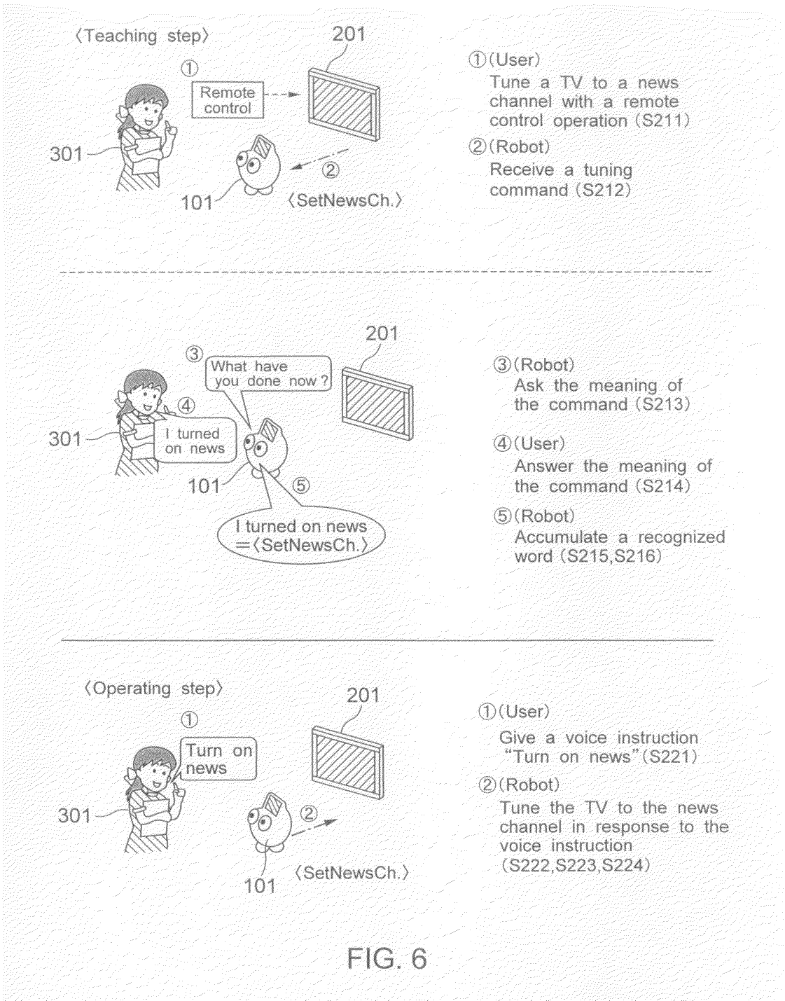

FIG. 5 shows a configuration of an interface apparatus 101 according to a second embodiment. FIG. 6 illustrates the operation of the interface apparatus 101 in FIG. 5. The second embodiment is a variation of the first embodiment and will be described mainly focusing on its differences from the first embodiment.

As shown in FIG. 5, the interface apparatus 101 includes a speech recognizing section 111, an accumulating section 112, a matching section 113, a device operating section 114, an operation detecting section 121, a status detecting section 122, an operation history accumulating section 123, an operation history matching section 124, an utterance section 125 that has a corresponding word retrieving section 131 and a corresponding word utterance section 132, and a query section 141.

The query section 141 is a block which queries (asks) a user by voice about the meaning of a status change or status continuance detected by the status detecting section 122. The speech recognizing section 111 is a block which performs speech recognition or has a speech recognizing unit 401 perform speech recognition, for a teaching speech uttered by the user in response to the query and an instructing speech uttered by a user for a device operation. The speech recognizing unit 401 is configured to perform speech recognition. The accumulating section 112 is a block which accumulates a recognition result for the teaching speech and a detection result for the status change or status continuance in association with each other. The matching section 113 is a block which selects, based on a matching result of matching a recognition result for the instructing speech against accumulated recognition results for teaching speeches, a device operation specified by a detection result for a status change or status continuance that corresponds to the recognition result for the instructing speech. The device operating section 114 is a block which performs the selected device operation.

The operation detecting section 121 is a block which detects a device operation. The status detecting section 122 is a block which detects a status change or status continuance of a device or in the vicinity of the device. The operation history accumulating section 123 is a block which accumulates a detection result for the device operation and a detection result for the status change or status continuance in association with each other. The operation history matching section 124 is a block which matches a detection result for a newly detected status change or status continuance against accumulated detection results for status changes or status continuances, and selects a device operation that corresponds to the detection result for the newly detected status change or status continuance. The utterance section 125 is a block which utters as sound a word corresponding to the selected device operation. In the utterance section 125, the corresponding word retrieving section 131 retrieves a word to utter, from words which are obtained from recognition results for teaching speeches accumulated in the accumulating section 112, and the corresponding word utterance section 132 utters the retrieved word as sound.

As shown in FIG. 6, operation phases of the interface apparatus 101 include an operation history accumulation phase in which an operation history of the device 201 is accumulated, an operation history utilizing phase in which the operation history of the device 201 is utilized, and a teaching speech accumulating phase in which a teaching speech is accumulated.

In the teaching speech accumulating phase, the user 301 operates a remote control with his/her hand to tune the television 201 to the news channel (S211). At this time, the status detecting section 122 of the interface apparatus 101 receives a remote control signal associated with the operation of tuning the television 201 to the news channel (S212). As a result of this, the status detecting section 122 detects a status change of the television 201 such that the television 201 was tuned to the news channel. If the television 201 is connected to a network, the status detecting section 122 receives the remote control signal from the television 201 via the network, or if the television 201 is not connected to a network, the status detecting section 122 receives the remote control signal directly from the remote control.

At S112 in the first embodiment, the operation detecting section 121 receives the remote control signal, whereas the status detecting section 122 receives the remote control signal, at S212 in the second embodiment. This is due to the fact that the status change or status continuance of the television 201 or in the vicinity of the television 201 which is detected at S212 happens to be relevant to a device operation for the television 201. Therefore, in the second embodiment, S212 may be performed by the operation detecting section 121. This is interpreted as follows: S212 is performed by the operation detecting section 121 which is a part of the status detecting section 122.

Then, the matching section 113 of the interface apparatus 101 matches a command of the remote control signal against commands accumulated in the accumulating section 112. When the television 201 is a network appliance, the command of the remote control signal is a tuning command <SetNewsCh>, and when the television 201 is not a network appliance, the command of the remote control signal is a signal code itself.

When the command of the remote control signal is an unknown command, the query section 141 queries (asks) the user 301 about the meaning of the command in the remote control signal, i.e., the meaning of the status change detected by the status detecting section 122, by speaking as “What have you done now?” (S213). If the user 301 answers “I turned on news” within a certain time period in response to the query (S214), the speech recognizing section 111 starts speech recognition process, for the teaching speech “I turned on news” uttered by the user 301 (S215).

At S215, the speech recognizing section 111 has the speech recognizing unit 401 perform speech recognition for the teaching speech “I turned on news”. Here, the speech recognizing unit 401 is a speech recognition server for continuous speech recognition. Accordingly, the speech recognizing unit 401 performs continuous speech recognition, as speech recognition for the teaching speech “I turned on news”. Then, the speech recognizing section 111 acquires a recognition result for the teaching speech “I turned on news” from the speech recognizing unit 401. The speech recognizing section 111 may perform speech recognition for the teaching speech by itself, instead of having the speech recognizing unit 401 perform it.

Then, the interface apparatus 101 accumulates a recognized word(s) “I turned on news” which is the recognition result for the teaching speech, and the command <SetNewsCh> which is the detection result for the status change, in association with each other, in the accumulating section 112 (S216).

Subsequently, in the operation history accumulating phase, the user 301 says “Turn on news” to the interface apparatus 101 in order to turn on the television 201 and watch the news channel (S221). This is similar to S121 in the first embodiment. In response to it, the speech recognizing section 111 of the interface apparatus 101 starts speech recognition process, for the instructing speech “Turn on news” uttered by the user 301 for a device operation (S222). This is similar to S122 in the first embodiment.

At S222, the speech recognizing section 111 has the speech recognizing unit 401 perform speech recognition for the instructing speech “Turn on news”. Here, the speech recognizing unit 401 is a speech recognition server for continuous speech recognition. Accordingly, the speech recognizing unit 401 performs continuous speech recognition, as speech recognition for the instructing speech “Turn on news”. Then, the speech recognizing section 111 acquires a recognition result for the instructing speech “Turn on news” from the speech recognizing unit 401. The speech recognizing section 111 may perform speech recognition for the instructing speech by itself, instead of having the speech recognizing unit 401 perform it. The speech recognizing section 111 may have a speech recognizing unit other than the speech recognizing unit 401 perform speech recognition for the instructing speech.

Then, the matching section 113 of the interface apparatus 101 matches the recognition result for the instructing speech “Turn on news” against recognition results for accumulated teaching speeches in the accumulating section 112. The matching section 113 selects, based on a matching result of matching these recognition results, a device operation specified by a detection result for a status change or states continuance that corresponds to the recognition result for the instructing speech “Turn on news” (S223). This is similar to S123 in the first embodiment. Here, this matching process provides a matching result such that the recognition result for the instructing speech “Turn on news” corresponds to the recognition result for the teaching speech “I turned on news”. Based on this matching result, the command <SetNewsCh>, i.e., the device operation of tuning the TV to the news channel, is selected.

At S223, the teaching speech “I turned on news (in Japanese ‘nyusu tsuketa’)” and the instructing speech “Turn on news (in Japanese ‘nyusu tsukete’)”, which are partially different, are matched against each other, and it gives a matching result such that they correspond to each other. Such matching process can be realized, for example, by analyzing conformity at morpheme level between the result of continuous speech recognition for the teaching speech and the result of continuous speech recognition for the instructing speech. According to an example of this analysis process, the conformity is analyzed quantitatively by quantifying the conformity, similar to quantifying the degree of similarity described above.

Then, the device operating section 114 of the interface apparatus 101 performs the device operation selected by the matching section 113 (S224). That is, the television 201 is turned on and tuned to the news channel. This is similar to S124 in the first embodiment. Subsequently, processes similar to those performed from S125 to S127 in the first embodiment will be performed.

In the teaching speech accumulating phase from S211 to S216, the recognition result for the teaching speech (“I turned on news”) and the detection result for the status change (<SetNewsCh>) are accumulated in association with each other, in the accumulating section 112. In such teaching speech accumulating phase, recognition results for various teaching speeches and detection results for various status changes are accumulated in association with each other, in the accumulating section 112 of the interface apparatus 101.

Accordingly, at S222, the speech recognizing section 111 may utilize, as a standby word, a word acquired from the recognition results for teaching speeches, in order to perform isolated word recognition as speech recognition for an instructing speech. For example, if a recognition result for a teaching speech is “I turned on news” or “I tuned up the volume”, the word “news” or “volume” which is acquired by extracting a part from the recognition result is utilized as a standby word for isolated word recognition. For example, if a recognition result for a teaching speech is “Record” or “Replay”, the word “record” or “replay” which is acquired by extracting all from the recognition result is utilized as a standby word for isolated word recognition.

Consequently, at S222, the recognition result for the instructing speech is matched against these recognition results for teaching speeches, and it is determined whether or not the recognition result for the instructing speech corresponds to any of these recognition results for teaching speeches. For example, this determination gives a matching result such that the recognition result for the instructing speech “Turn on news” contains the word “news”, and the recognition result for the instructing speech “Turn on news” corresponds to the recognition result for the teaching speech “I turned on news”. Then, at S223, based on the matching result, the command <SetNewsCh>, i.e., the device operation of tuning the TV to the news channel, is selected. Then, at S224, the television 201 is turned on and tuned to the news channel. Subsequently, processes similar to those performed from S125 to S127 in the first embodiment will be performed.

As stated above, at S122 in the first embodiment, the interface apparatus 101 performs isolated word recognition, utilizing a word accumulated in the accumulating section 112. Meanwhile, at S222 in the second embodiment, the interface apparatus 101 can perform isolated word recognition, utilizing a word acquired from recognition results for teaching speeches which are accumulated in the accumulating section 112. That is to say, the operation history accumulating process and operation history utilizing process of the first embodiment can be realized, in the second embodiment, by utilizing a word acquired from recognition results for teaching speeches, as a standby word for isolated word recognition. In the first embodiment, the standby word for isolated word recognition may be 1) a word which is acquired in a similar way to the second embodiment and accumulated in the accumulating section 112, 2) a word which is accumulated by the manufacturer of the interface apparatus 101 in the accumulating section 112, or 3) a word which is accumulated by the user of the interface apparatus 101 in the accumulating section 112.

Process of acquiring a word from recognition results for teaching speeches can be automated in various ways. An example of possible way is to refer recognition results for teaching speeches corresponding to a detection result for a status change, and acquire a word that has the highest frequency of occurrence. For example, when three teaching speeches “I turned on news”, “I chose news”, and “I switched to the news channel” have been obtained for a status change of tuning the TV to the news channel, the word “news” is obtained. Separation between words can be analyzed through morpheme analysis.

Then, in the operation history utilizing phase, processes similar to those performed from S131 to S134 in the first embodiment are performed. At S134, the utterance section 125 retrieves a word to utter, from words which are obtained from recognition results for teaching speeches accumulated in the accumulating section 112, and utters the retrieved word as sound. Here, from words such as “news”, “volume”, “recording”, “replay” and the like, the word “news” that corresponds to the device operation of tuning the TV to the news channel is acquired in the retrieval. Then, the utterance section 125 utters as sound the word “news” which is acquired in the retrieval. The utterance section 125 may utter the word alone, or may utter the word together with some other word like “I turned on news”.

In this embodiment, a word that is obtained from recognition results for teaching speeches accumulated in the accumulating section 112 is used as a standby word for isolated word recognition, in performing speech recognition for an instructing speech. Therefore, in this embodiment, the user 301 can utter the word “news” as an instructing speech, to have the interface apparatus 101 tune the TV to the news channel. In other words, the utterance by the utterance section 125 has an effect of presenting the user 301 with a voice instruction word “news” for tuning the TV to the news channel.

As described above, in this embodiment, a voice instruction word can be obtained from recognition results for teaching speeches. Therefore, an expression unique to the user, an abbreviated name of a television program and the like, which are difficult to register in advance, can be used as voice instruction words. In this embodiment, such a voice instruction word is to be a word which is uttered by the utterance section 125. Accordingly, by uttering such a voice instruction word, the interface apparatus 101 can remind the user 301 of a certain act performed in a certain situation by the user 301, with a personalized voice instruction word, such as an expression unique to the user, an abbreviated name of a television program or the like.

### Third Embodiment

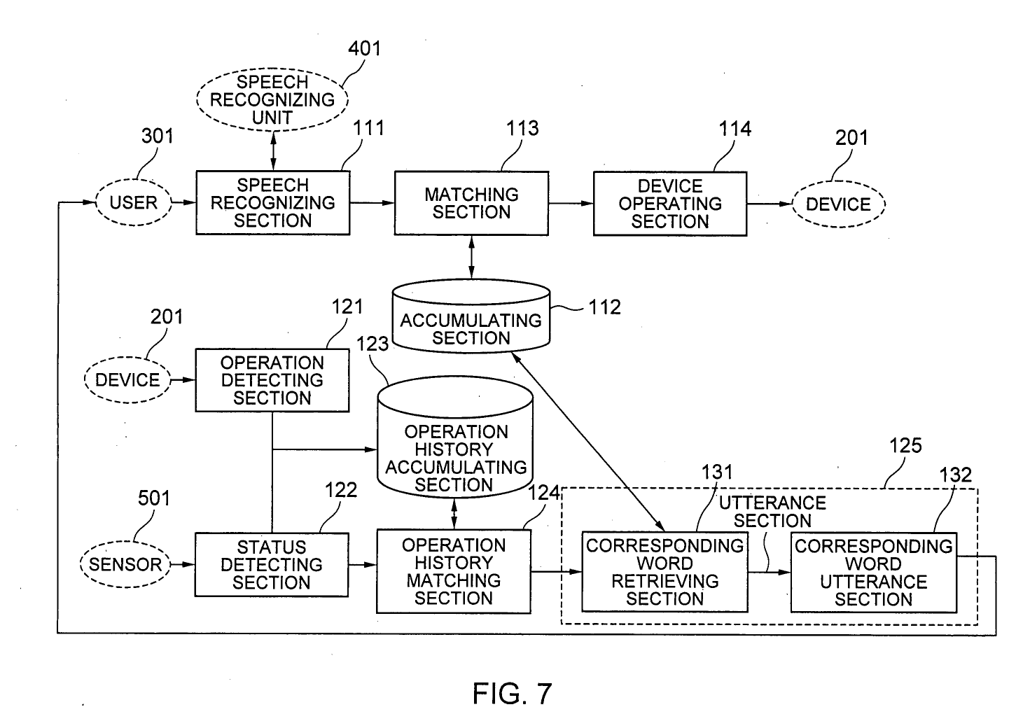

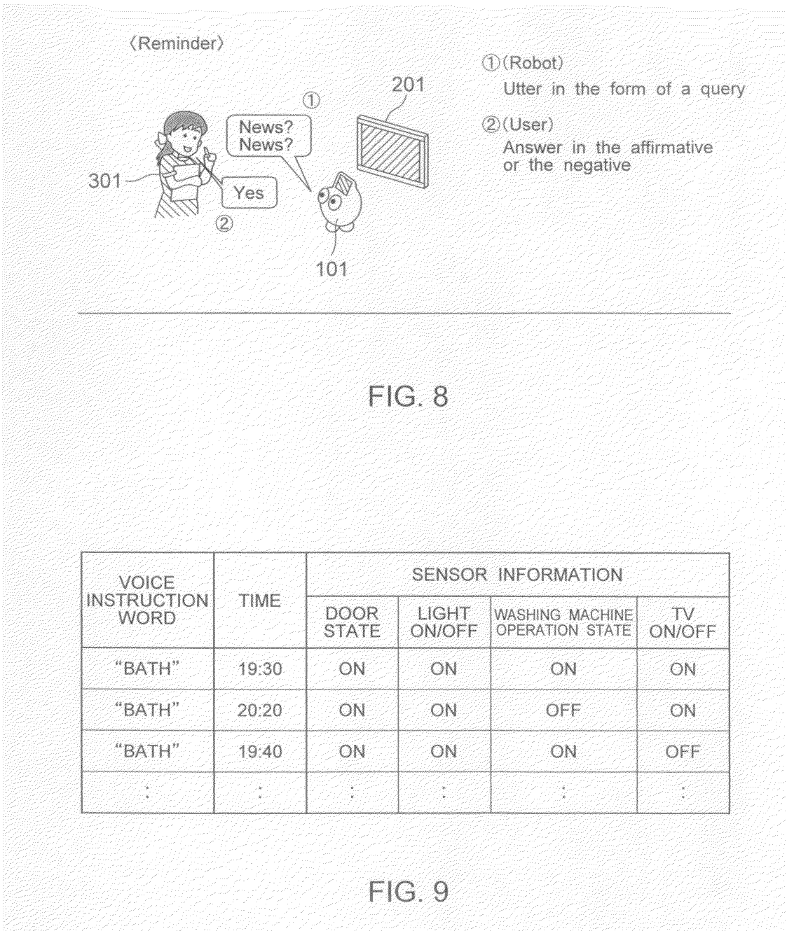

FIG. 7 shows a configuration of an interface apparatus 101 according to a third embodiment. FIG. 8 illustrates the operation of the interface apparatus 101 in FIG. 7. The third embodiment is a variation of the first embodiment and will be described mainly focusing on its differences from the first embodiment.

Operation phases of the interface apparatus 101 include an operation history accumulating phase in which an operation history of the device 201 is accumulated, and an operation history utilizing phase in which the operation history of the device 201 is utilized. In the operation history accumulating phase, processes similar to those performed from S111 to S114 or from S121 to S127 in the first embodiment are performed. In the operation history utilizing phase, processes similar to those performed from S131 to S134 in the first embodiment are performed.

At S134 in the first embodiment, the utterance section 125 utters as sound a word “news” that corresponds to the device operation of tuning the TV to the news channel. At S134 in the third embodiment, the utterance section 125 utters the word in the form of a query to the user 301, as illustrated in FIG. 8. That is, the utterance section 125 utters as “News?”. The utterance section 125 may utter the word alone, or may utter the word together with some other word like “I turn on news?” or “You watch news?”.

In such a manner, the utterance section 125 utters the word in a form that allows the user 301 to answer the query in the affirmative or the negative. The user 301 can answer in the affirmative as “Yes” if he/she wants to watch the news channel, and can answer in the negative as “No” if he/she does not want to watch the news channel.

The speech recognizing section 111 waits for a response to the query with an affirmative standby word (i.e., an affirmative word) and a negative standby word (i.e., a negative word), for a certain time period after giving the query. An example of the affirmative word is “yes”, and an example of the negative word is “no”. Other examples of the affirmative word include “yeah” and “right”. When the query is “I turn on news?” or “You watch news?”, “You can” or “I do” also serves as an affirmative standby word, and “You can't” or “I don't” also serves as a negative standby word. When the query is “News?”, “news” also serves an affirmative standby word.

As described above, in this embodiment, the utterance section 125 utters the word in the form of a query to the user 301. This produces a situation in which the user 301 can easily give a voice instruction, because such a situation in which the user 301 answers the query from the interface apparatus 101 resembles a situation in which persons talk to each other.

In addition, in this embodiment, the utterance section 125 utters the word in a form that allows the user 301 to answer the query in the affirmative or the negative. Consequently, the speech recognizing section 111 can limit standby words to a small vocabulary, during standby (i.e., isolated word recognition) after the query. This is because standby words can be limited to affirmative words and negative words. This reduces processing load of speech recognition process involved in standby.

### Fourth Embodiment

The first embodiment illustrated a door sensor, as an example of the sensor 501 for detecting a status change or status continuance of the device 201 or in the vicinity of the device 201. Other examples of a status change (i.e., a change of the status) or a status continuance (i.e., a continuance of the status) that can be detected with the sensor 501 and the like include, the turning on/off of an electric light, the operation state of a washing machine, the state of a bath boiler, the title of a television program being watched, the name of a user who is present in the vicinity of a device, and the like.

The turning on/off of an electric light, the operation state of a washing machine, and the state of a bath boiler can be obtained via a network, if these devices are connected to a network. The turning on/off of an electric light can also be detected through a change of an illuminance sensor. The title of a television program being watched can be extracted, for example, from an electronic program guide (EPG), the channel number of the channel which is currently watched, and the current time. The user's name can be obtained by setting a camera around the device, recognizing the user's face with a camera-based face recognition technique, and identifying the user's name from a recognition result for the user's face.

A detection result for such a status change or status continuance is accumulated in the operation history accumulating section 123, in association with a detection result for a device operation, as shown in FIG. 9. FIG. 9 shows an example of accumulated data in the operation history accumulating section 123 according to the fourth embodiment.

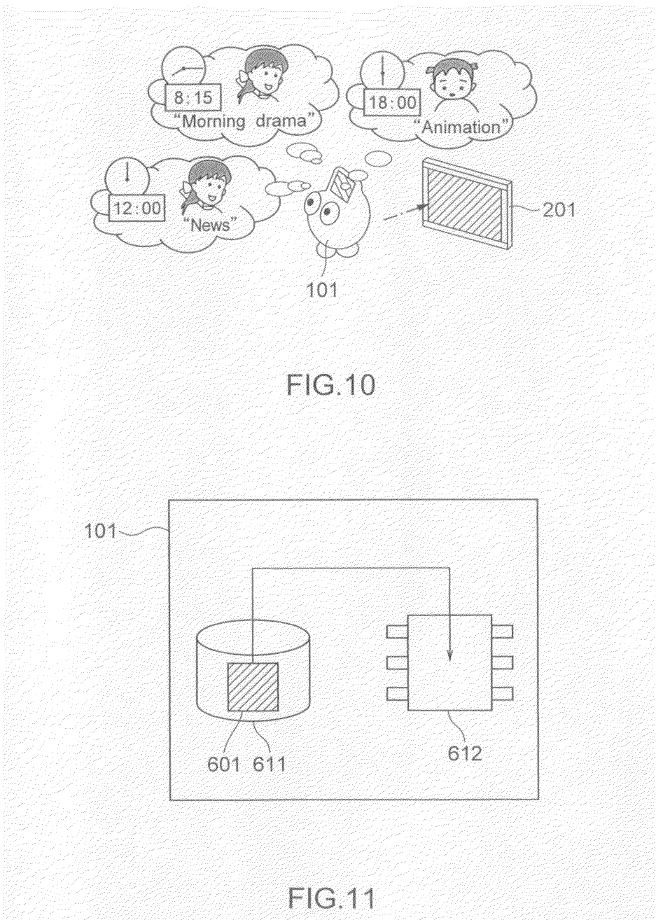

FIG. 10 illustrates the operation of the interface apparatus 101 according to the fourth embodiment.

Suppose that in the morning on a day, a washing machine is turned on, and then the face of user 1 (mother) is recognized by a camera. At this time, the interface apparatus 101 can utter “You watch AAA?” taking into consideration that a television program the user 1 watches every morning is a drama “AAA”. If the user 1 gives an affirmative answer in response to it, the interface apparatus 101 can turn on the television and tune it to the channel for the drama.

This serves as a reminder when the user 1 forgets that the drama will start. Moreover, when the user 1 is likely to watch the drama every morning, the interface apparatus 101 may voluntarily turn on the television and tune it to the channel for the drama, while uttering “AAA, AAA” without asking the user 1.

Suppose that in the evening on a day, an electric light in the room with the television turns on, and then the face of user 2 (child) is recognized by a camera. At this time, the interface apparatus 101 can utter “You watch BBB?” taking into consideration that a television program the user 2 watches every evening is an animation “BBB”. If the user 2 gives an affirmative answer in response to it, the interface apparatus 101 can turn on the television and tune it to the channel for the animation.

Suppose a user who always goes home at around 9:00 at night and soon takes a bath. In this case, the interface apparatus 101 utters “Bath? Bath?”, when there is a response of the door sensor at the front door around that time. If the user gives an affirmative answer in response to it, the interface apparatus 101 can operate the bath boiler.

Suppose a user who usually turns off a television, then turns off a room light, before going to bed at night (around 12:00). In this case, the interface apparatus 101 utter “Room light? Room light?”, when the television is turned off around that time. If the user gives an affirmative answer in response to it, the interface apparatus 101 can operate the room light.

The process performed by the interface apparatus 101 according to any of the first through fourth embodiments can be realized, for example, by a computer program (an interface processing program). For example, such a program 601 is stored in a storage 611 in the interface apparatus 101, and executed by a processor 612 in the interface apparatus 101, as shown in FIG. 11.

As has been described above, the embodiments of the present invention provide a user-friendly speech interface which serves as an intermediary between a device and a user.

What is claimed is:

1. An interface apparatus, comprising:
an operation detecting section configured to detect a device operation;
a status detecting section configured to detect a status change or status continuance of a device or in the vicinity of the device;
an operation history accumulating section configured to accumulate a operation detection result and a status detection result in association with each other;
an operation history matching section configured to match a status detection result for a newly detected against accumulated status detection results, and select a device operation that corresponds to the status detection result for the newly detected; and
an utterance section configured to utter as sound a word corresponding to the selected device operation.

2. The apparatus according to claim 1, wherein the operation detecting section detects a device operation performed by a user.

3. The apparatus according to claim 1, wherein the operation detecting section detects a device operation performed by the apparatus in response to a voice instruction from a user.

4. The apparatus according to claim 3, wherein the utterance section utters, as the word, a voice instruction word for the selected device operation.

5. The apparatus according to claim 1, wherein the operation history matching section quantifies the degree of similarity between the status detection result for the newly detected and an accumulated status detection result, and selects a device operation that corresponds to the status detection result for the newly detected, based on the degree of similarity.

6. The apparatus according to claim 5, wherein the utterance section utters the word in a manner depending on the degree of similarity.

7. The apparatus according to claim 6, wherein the utterance section changes the volume of utterance or the number of utterances of the word, in accordance with the degree of similarity.

8. The apparatus according to claim 6, wherein the apparatus utters the word through the utterance section with a physical movement, in a manner depending on the degree of similarity.

9. The apparatus according to claim 1, further comprising:
a query section configured to query a user by voice about the meaning of the status change or status continuance detected by the status detecting section;
a speech recognizing section configured to perform speech recognition or have one or more speech recognizing units perform speech recognition, for a teaching speech uttered by the user in response to the query and an instructing speech uttered by a user for a device operation, the one or more speech recognizing units being configured to perform speech recognition;
an accumulating section configured to accumulate a recognition result for the teaching speech and a status detection result in association with each other;
a matching section configured to select, based on a matching result of matching a recognition result for the instructing speech against accumulated recognition results for teaching speeches, a device operation specified by a status detection result that corresponds to the recognition result for the instructing speech; and
a device operating section configured to perform the selected device operation, wherein
the operation detecting section detects the device operation performed by the device operating section, and
the utterance section retrieves a word to utter, from words which are obtained from the accumulated recognition results for teaching speeches, and utters the retrieved word as sound.

10. The apparatus according to claim 9, wherein
the speech recognizing section performs speech recognition or has the one or more speech recognizing units perform speech recognition, by continuous speech recognition, for the teaching speech, and
the speech recognizing section performs speech recognition or has the one or more speech recognizing units perform speech recognition, by continuous speech recognition or isolated word recognition, for the instructing speech.

11. The apparatus according to claim 10, wherein the utterance section retrieves a word to utter, from standby words for the isolated word recognition which are obtained from the accumulated recognition results for teaching speeches, and utters the retrieved standby word as sound.

12. The apparatus according to claim 1, wherein the utterance section utters the word in the form of a query to a user.

13. An interface processing method, comprising:
detecting a device operation;
detecting a status change or status continuance of a device or in the vicinity of the device;
accumulating a operation detection result and a status detection result in association with each other;
matching a status detection result for a newly detected against accumulated status detection results, and selecting a device operation that corresponds to the status detection result for the newly detected; and
uttering as sound a word corresponding to the selected device operation.

14. An interface processing method, comprising:
detecting a status change or status continuance of a device or in the vicinity of the device;
querying a user by voice about the meaning of the detected status change or status continuance;
performing speech recognition or having a speech recognizing unit perform speech recognition, for a teaching speech uttered by the user in response to the query, the speech recognizing unit being configured to perform speech recognition;
accumulating a recognition result for the teaching speech and a status detection result in association with each other;
performing speech recognition or having a speech recognizing unit perform speech recognition, for an instructing speech uttered by a user for a device operation, the speech recognizing unit being configured to perform speech recognition;
selecting, based on a matching result of matching a recognition result for the instructing speech against accumulated recognition results for teaching speeches, a device operation specified by a status detection result that corresponds to the recognition result for the instructing speech;
performing the selected device operation;
detecting the performed device operation;
detecting a status change or status continuance of a device or in the vicinity of the device;
accumulating a operation detection result and a status detection result in association with each other;
matching a status detection result for a newly detected against accumulated status detection results, and selecting a device operation that corresponds to the status detection result for the newly detected; and
retrieving a word corresponding to the selected device operation, from words which are obtained from the accumulated recognition results for teaching speeches, and uttering the retrieved word as sound.

15. The method according to claim 13, wherein
in the matching of a status detection result for a newly detected against accumulated status detection results, and the selecting of a device operation that corresponds to the status detection result for the newly detected,
the degree of similarity between the status detection result for the newly detected and an accumulated status detection result is quantified, and a device operation that corresponds to the status detection result for the newly detected is selected based on the degree of similarity.

16. The method according to claim 13, wherein in the uttering, the word is uttered in the form of a query to a user.

17. An interface processing program of having a computer perform an interface processing method, the method comprising:
detecting a device operation;
detecting a status change or status continuance of a device or in the vicinity of the device;
accumulating a operation detection result and a status detection result in association with each other;
matching a status detection result for a newly detected against accumulated status detection results, and selecting a device operation that corresponds to the status detection result for the newly detected; and
uttering as sound a word corresponding to the selected device operation.

18. An interface processing program of having a computer perform an interface processing method, the method comprising:
detecting a status change or status continuance of a device or in the vicinity of the device;
querying a user by voice about the meaning of the detected status change or status continuance;
performing speech recognition or having a speech recognizing unit perform speech recognition, for a teaching speech uttered by the user in response to the query, the speech recognizing unit being configured to perform speech recognition;
accumulating a recognition result for the teaching speech and a status detection result in association with each other;
performing speech recognition or having a speech recognizing unit perform speech recognition, for an instructing speech uttered by a user for a device operation, the speech recognizing unit being configured to perform speech recognition;
selecting, based on a matching result of matching a recognition result for the instructing speech against accumulated recognition results for teaching speeches, a device operation specified by a status detection result that corresponds to the recognition result for the instructing speech;
performing the selected device operation;
detecting the performed device operation;
detecting a status change or status continuance of a device or in the vicinity of the device;
accumulating a operation detection result and a status detection result in association with each other;
matching a status detection result for a newly detected against accumulated status detection results, and selecting a device operation that corresponds to the status detection result for the newly detected; and
retrieving a word corresponding to the selected device operation, from words which are obtained from the accumulated recognition results for teaching speeches, and uttering the retrieved word as sound.

19. The program according to claim 17, wherein
in the matching of a status detection result for a newly detected against accumulated status detection results, and the selecting of a device operation that corresponds to the status detection result for the newly detected,
the degree of similarity between the status detection result for the newly detected and an accumulated status detection result is quantified, and a device operation that corresponds to the status detection result for the newly detected is selected based on the degree of similarity.

20. The program according to claim 17, wherein in the uttering, the word is uttered in the form of a query to a user.
